(19) United States
(12) Patent Application Publication
(10) Pub. No.: US 2015/0155152 A1
(43) Pub. Date: Jun. 4, 2015

(54) MASS SPECTROMETRY APPARATUS

(71) Applicant: FUJIFILM Corporation, Tokyo (JP)

(72) Inventors: Shogo YAMAZOE, Ashigarakami-gun (JP); Masayuki NAYA, Ashigarakami-gun (JP)

(73) Assignee: FUJIFILM Corporation, Tokyo (JP)

(21) Appl. No.: 14/619,410

(22) Filed: Feb. 11, 2015

Related U.S. Application Data
(63) Continuation of application No. PCT/JP2013/004716, filed on Aug. 5, 2013.

(30) Foreign Application Priority Data
Aug. 14, 2012 (JP) 2012-179702

(51) Int. Cl. H01J 49/16; H01J 49/40

(52) U.S. Cl. CPC H01J 49/164; H01J 49/40

(57) ABSTRACT

The mass spectrometry apparatus is constituted by a sample plate to which a measurement target substance is adhered, the sample plate being transparent to a laser beam; a support mount on which the sample plate is placed, a part of the support mount being a light transmitting portion that transmits a laser beam; a light irradiation unit that exposes the measurement target substance to a laser beam from the back side of the sample plate and is provided with a laser source that outputs a laser beam, a collecting lens that collects a laser beam onto the measurement target substance, and an aberration-correction mechanism that corrects aberration which occurs when the laser beams are collected; and a detector that detects the measurement target substance which has been desorbed from the surface of the sample plate and ionized, by being irradiated with a laser beam.

### CROSS-REFERENCE TO RELATED APPLICATIONS

This application is a Continuation of PCT International Application No. PCT/JP2013/004716 filed on Aug. 5, 2013, which claims priority under 35 U.S.C. §119(a) to Japanese Patent Application No. 2012-179702 filed on Aug. 14, 2012. Each of the above applications is hereby expressly incorporated by reference, in its entirety, into the present application.

### BACKGROUND OF THE INVENTION

1. Field of the Invention

The present invention relates to a mass spectrometry apparatus that desorbs a sample in contact with a surface of a substrate from the surface of the substrate, captures a measurement target substance, which is ionized within the sample, and performs mass spectrometry on the substance.

2. Description of the Related Art

As mass spectrometry for identifying a substance or the like, a mass spectrometry method (Mass Spectrometry) in which a measurement target substance adhered to a surface of a substrate is caused to be desorbed from the surface of the substrate and ionized, and the substance is identified based on the ratio of the mass of the substance to the charge thereof is known. For example, in time-of-flight mass spectrometry (Time of Flight Mass Spectroscopy: TOF-MS), an ionized measurement target substance is caused to fly between high-voltage electrodes for a predetermined distance, and the mass of the substance is analyzed based on the time period of flight of the substance.

Examples of such mass spectrometry methods in which the measurement target substance is desorbed and ionized include the MALDI method (matrix-assisted laser desorption/ionization) and the SALDI method (surface-assisted laser desorption ionization).

In the MALDI method, a sample formed by mixing a measurement target substance into a matrix (for example, sinapinic acid, glycerin or the like) is irradiated with light and energy of the irradiated light is absorbed by the matrix. Further, the measurement target substance is vaporized together with the matrix, and the measurement target substance is ionized by causing movement of protons between the matrix and the measurement target substance.

The MALDI method is widely used as a soft ionization method, which induces relatively small chemical changes, such as fragmentation and denaturation, in the measurement target substance in mass spectrometry of refractory substances and biomolecules, as well as high molecular weight substances, such as a synthetic high polymer and the like. (Patent Document 1 (Japanese Unexamined Patent Publication No. 9 (1997)-320515), and the like)

However, when the measurement target substance is a synthetic high polymer or the like, solubility to a solvent, the polarity of a polymer chain and the like greatly differ according to differences in the chemical structure of the polymer chain. Further, even if the main chain structure is the same, various properties of the measurement target substance differ according to differences in average molecular weights, the chemical structures of end groups, and the like. Therefore, it is necessary to optimize the kind of a matrix material and the method for preparing the crystal based on the kind of the measurement target substance.

Meanwhile, the SALDI method is a method in which a function for assisting desorption and ionization of the measurement target substance is provided in a mass spectrometry device itself to carry out soft ionization. For example, in Patent Documents 2 and 3 (U.S. Patent Application Publication No. 20080073512 and U.S. Patent Application Publication No. 20060157648), soft ionization is carried out by utilizing a mutual reaction between a silicon nanostructure and a laser beam in a mass spectrometry device equipped with a porous silicon substrate, which has a nano-order porous structure on the surface thereof.

Further, in Patent Document 4 (Japanese Unexamined Patent Publication No. 2009-081055), a mass spectrometry device in which metal micro particles are dispersed on a silicon substrate is utilized, and soft ionization is carried out by utilizing surface plasmons, which are generated on a surface of the metal micro particles when the device is irradiated with a laser beam.

In these mass spectrometry methods that employ laser desorption and ionization, two-dimensional mass spectrometry data of the measurement target substance can be obtained as image data by sweeping a laser beam within the two-dimensional range within a surface of the measurement target substance, as disclosed in Patent Document 5 (Japanese Patent No. 4614000).

### SUMMARY OF THE INVENTION

The spatial resolution of the image data of the two-dimensional mass spectrometry data obtained in a manner as described above depends on the spot diameter of a laser beam on a measurement target substance. In other words, when the spot diameter of the laser beam is made smaller and the area in which the measurement target substance is desorbed and ionized is narrowed, the spatial resolution becomes higher. Here, it is necessary to collect a laser beam with a large numerical aperture (NA) so as to reduce the spot diameter of the laser beam. Therefore, use of a collecting lens with a large diameter or use of a lens with a short focal length are considered in order to increase the numerical aperture.

However, in conventional mass spectrometry apparatuses, it is necessary for a laser beam to be emitted from and collected at a position above a measurement target substance. Therefore, when a lens with a large numerical aperture is used, there is a possibility that the lens will obstruct a path in which an ionized measurement target substance moves to a mass spectrometry unit and it is difficult to perform mass spectrometry normally. Hence, the resolution cannot be improved sufficiently.

The present invention has been developed in view of the foregoing circumstances. It is an object of the present invention to provide a mass spectrometry apparatus that is capable of improving resolution.

A mass spectrometry apparatus of the present invention includes a sample plate to which a measurement target substance is adhered, the sample plate being transparent to a laser beam;

a support mount on which the sample plate is placed, a part of the support mount being a light transmitting portion that transmits a laser beam;

a light irradiation unit that is disposed on a side opposite a surface on which the sample plate is placed in the support mount, that causes a laser beam to pass through the light transmitting portion of the support mount, and that irradiates the laser beam onto the measurement target substance from the back side of the sample plate, the light irradiation unit being provided with a laser source that outputs the laser beam, a collecting lens that collects the laser beam onto the measurement target substance, and an aberration-correction mechanism that corrects aberration which occurs when the laser beam is collected; and

a detector that detects the measurement target substance which has been desorbed from the surface of the sample plate and ionized, by irradiation with the laser beam.

Here, the expression “transparent” means that the transmittance of incident light is greater than or equal to 50%. Note that it is preferable for the transmittance to be greater than or equal to 75%.

In the mass spectrometry apparatus of the present invention, it is preferable for a two-dimensional scanning mechanism, which causes the laser beam to perform two-dimensional scanning in an in-plane direction of the sample plate, to be provided.

Further, it is preferable for the support mount to include a main body of the support mount which is constituted by a conductive member, the light transmitting portion of the conductive member being an opening; and a light-transmitting conductive film which is provided at the opening to be coplanar with the surface on which the sample plate is placed.

The light-transmitting conductive film provided on the support mount may be made of a transparent oxidized conductive material.

Further, the light-transmitting conductive film provided on the support mount may be a metal mesh.

It is preferable for the sample plate to have a substrate that is transparent to the laser beam and a metal microstructure formed on the substrate, which can excite localized plasmons by irradiation with the laser beam.

It is preferable for an ionization accelerating agent to be adhered to the surface of the sample plate.

The two-dimensional scanning mechanism may be a plane-direction drive unit which is provided on the support mount.

Further, the two-dimensional scanning mechanism may be constituted by a laser beam sweeping unit which sweeps the laser beam in an in-plane direction on the sample plate and which is provided in the light irradiation unit.

It is preferable for the mass spectrometry apparatus to include an autofocus system which automatically adjusts focusing of the laser beam when the laser beam performs scanning.

In the mass spectrometry apparatus of the present invention, a sample plate that is transparent to a laser beam is used and the laser beam irradiates a measurement target substance from the back side of the sample plate, instead of from above the measurement target substance, the laser beam being transmitted through a portion of a support mount that supports the sample plate. Therefore, the collecting lens does not interrupt the trajectory of the measurement target substance. Further, the size of the collecting lens which collects the laser beam is not limited. Therefore, a lens, the numerical aperture of which is large, can be used. Further, as an aberration-correction mechanism is provided, it is possible to narrow down the spot diameter of the collected beam to near the diffraction limit. As the spot diameter of the collected beam can be narrowed down to near the diffraction limit by using a lens with a large numerical aperture, the resolution when two-dimensional image data is obtained can be improved sufficiently.

### BRIEF DESCRIPTION OF THE DRAWINGS

FIG. 1 is a schematic diagram illustrating the configuration of a mass spectrometry apparatus according to a first embodiment of the present invention;

FIG. 2 is a cross-sectional diagram illustrating a specific configuration of a sample plate (mass spectrometry device);

FIG. 3 is a top view and a cross-sectional diagram of a support mount;

FIG. 4 is a top view of a support mount of another example;

FIG. 5 is a schematic diagram illustrating the configuration of a mass spectrometry apparatus according to a second embodiment of the present invention;

FIG. 6A is a pattern diagram showing an example in which surface modification is applied onto a sample plate;

FIG. 6B is a pattern diagram illustrating a state in which substances to be measure are desorbing;

FIG. 7 is a perspective diagram illustrating another example of the mass spectrometry device;

FIG. 8 is a top view illustrating another example of the mass spectrometry device; and

FIG. 9 is a perspective diagram illustrating another example of the mass spectrometry device.

### DETAILED DESCRIPTION OF THE PREFERRED EMBODIMENTS

Hereinafter, a mass spectrometry apparatus according to an embodiment of the present invention will be described with reference to the Figures.

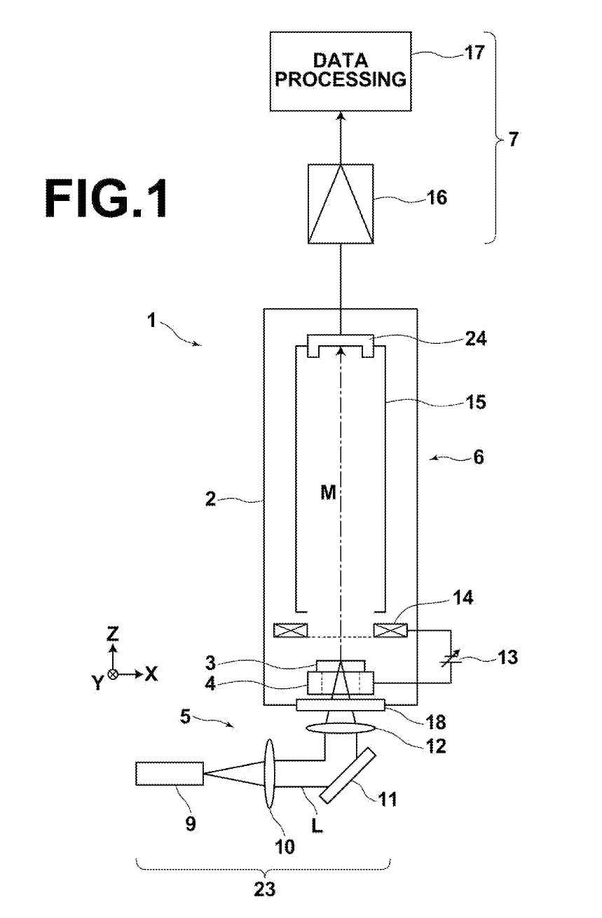

FIG. 1 is a schematic diagram illustrating the configuration of a mass spectrometry apparatus according to one embodiment of the present invention. The mass spectrometry apparatus 1 according to the present embodiment is a time-of-flight mass spectrometry apparatus (TOF-MS) by which a substance desorbed from a sample plate is caused to fly for a predetermined distance, and the mass of the substance is analyzed based on the time period of flight of the substance.

As illustrated in FIG. 1, the mass spectrometry apparatus 1 includes a vacuum chamber 2, a mass spectrometry device (hereinafter, referred to as “device”) 3 that is a sample plate which is disposed in the interior of the vacuum chamber 2 and to which a sample containing the measurement target substance M is adhered (or placed), a support mount 4 that supports the device 3, and a light irradiation unit 5 that irradiates the sample adhered to the device 3 with a measurement light L constituted by a laser beam to desorb the measurement target substance M contained in the sample from the device 3. Further, the mass spectrometry apparatus 1 includes a flight direction control unit 6 and a mass spectrometry unit 7. The flight direction control unit 6 causes the desorbed measurement target substance M to fly in a predetermined direction. The mass spectrometry unit 7 detects the desorbed measurement target substance M to analyze the mass of the measurement target substance M.

The vacuum chamber 2 enables the interior thereof to be vacuum, and a suction pump or the like (not shown) is connected thereto. In the vacuum chamber 2, air inside the chamber 2 is sucked by the suction pump in a hermetically sealed state to keep the vacuum state.

Further, the vacuum chamber 2 is provided with a window 18 that enables a measurement light L emitted from the light irradiation unit 5 to enter the interior of the vacuum chamber 2. The window 18 has pressure resistance which is high to a degree that is capable of being compatible with a difference in air pressure between the exterior and the interior of the vacuum chamber 2. Further, the window 18 is formed by a material that transmits the measurement light L with high transmittance.

The device 3 is a plate-like member constituted by a substrate and a metal microstructure layer that is formed thereon. The substrate is transparent and transmits the measurement light L with high transmittance. The metal microstructure layer excites localized plasmons by being irradiated with the measurement light L. Further, the device 3 is disposed in the interior of the vacuum chamber 2. Note that a sample containing the measurement target substance M is placed on the metal microstructure layer on the device 3.

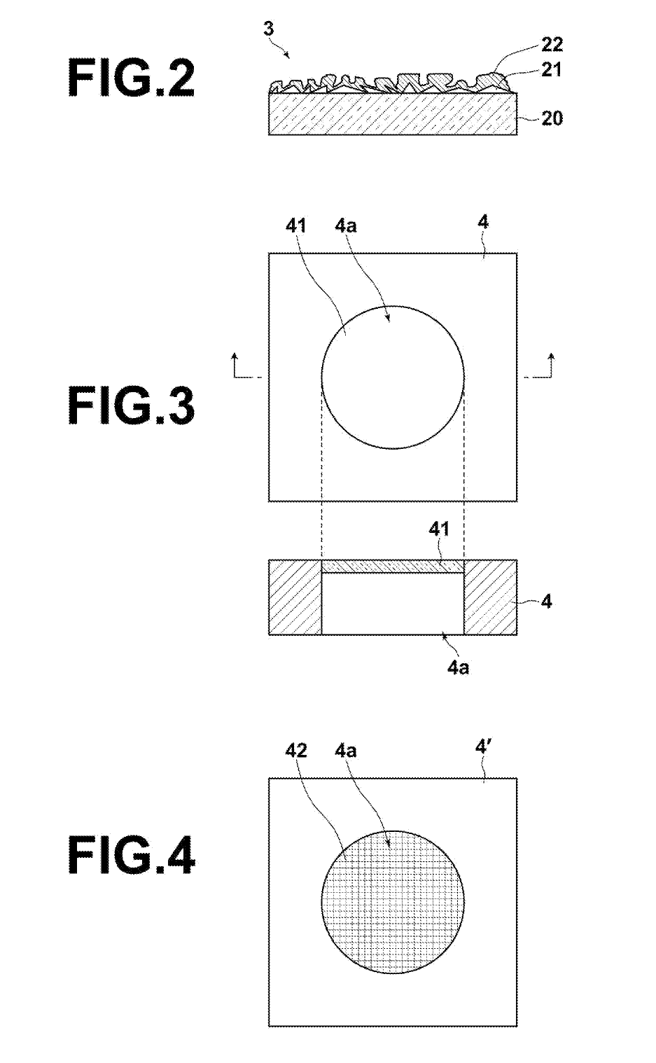

FIG. 2 is a cross-sectional diagram illustrating a portion of a specific example of the device 3.

As illustrated in FIG. 2, the device 3 includes a transparent and uneven microstructure 21 formed on a transparent substrate 20. Further, the metal microstructure layer 22 is provided on the uneven microstructure.

The substrate 20 is constituted by a dielectric material such as a glass, which has a high transmittance to the measurement light L. The uneven microstructure 21 formed on the substrate 20 is constituted by a transparent dielectric material. For example, the uneven microstructure 21 may be constituted by boehmite (AIO.OH) which is generated when the substrate 20 on which aluminum (Al) has been formed is subjected to a hydrothermal reaction.

The uneven microstructure 21 constituted by boehmite which has been produced by the hydrothermal reaction has convex portions. Each of the convex portions has an edge of approximately several 10 nm and is in the shape of a micro triangular pyramid. Accordingly, the uneven microstructure 21 is equivalent to a structure in which refractive indices gradually change with respect to measurement light which is in the range from visible light to near-infrared light. Therefore, the uneven microstructure 21 has high transmittance with respect to the measurement light L.

Various types of metals which generate localized plasmons may be used as materials for forming the metal microstructure layer 22. Examples of the metals may include Au, Ag, Cu, Al, Pt, Ni, Ti, and alloys thereof. Further, it is more desirable for the metal microstructure layer 22 to be formed by Au, Ag, or the like, so that an electric field enhancement effect can be enhanced further.

The metal microstructure layer 22 can be formed by vapor deposition of a metal onto the uneven microstructure 21.

When the pitch and/or the depth of the unevenness of the metal microstructure layer 22 is smaller than the wavelength of the measurement light L, localized plasmons can be induced by irradiation with the measurement light L. It is desirable for the pitch and depth of the unevenness to be less than or equal to 200 nm, and more desirably approximately between several nm and several 10 nm.

When measurement light irradiates the device 3 such as that described above, localized plasmons will be induced and an enhanced electric field will be formed on a surface of the metal microstructure layer.

Note that a mass spectrometry device provided with a metal microstructure layer is used as a sample plate in the present embodiment. However, any device which can be exposed to a laser beam emitted from the back side thereof may be utilized, and a sample plate constituted only by a glass plate may be employed. When a metal microstructure layer is not provided on the mass spectrometry device, no electric field enhancement effects by irradiation with the laser beam are obtained. Therefore, it is necessary to increase the power of the laser beam to desorb and ionize the measurement target substance. Hence, it is more desirable for a device provided with a metal microstructure layer to be used.

The support mount 4 supports the device 3 from a surface opposite a surface on which a sample is placed and fixes the device at a predetermined position. The support mount 4 is provided with an opening in the center thereof as a light transmitting portion that transmits the measurement light L. Further, the support mount 4 includes a mechanism that is capable of moving in an XY direction within the plane of the device. This mechanism capable of moving in an XY direction is a plane-direction drive unit (i.e., a XY stage), which constitutes a two-dimensional scanning mechanism that causes the measurement light to perform a two-dimensional scanning in an in-plane direction of the device.

Further, the support mount 4 may be capable of adjusting the position thereof in a Z direction.

A light irradiation unit 23 includes a laser source 9, a collimating lens 10 that collimates a laser beam which has been emitted in a diffused manner from the laser source 9, a mirror 11, and a collecting lens 12. The collecting lens 12 collects the laser beam, which has been collimated by the collimating lens 10 and reflected by the mirror 11, onto a sample on the device 3.

The laser source 9 emits a laser beam with a predetermined wavelength. Here, it is desirable that a pulsed laser is used as a laser source.

It is desirable for an objective lens or an aspherical surface lens with small aberration to be used as the collecting lens 12 to collect the laser beam up to the limit of diffraction. Note that it is desirable for a collecting lens having a numerical aperture (NA) to be utilized so as to obtain a sufficient resolution for when two-dimensional mass spectrum data is obtained (imaging). Specifically, when a single cell (approximately 10 μm) is presumed to be imaged, a resolution of approximately 1 μm is required. In the shortest wavelength of 300 nm of the excitation light which is presumed to be applied, a collecting lens, the NA of which is less than or equal to 0.35, is required to obtain that resolution. Further, it is desirable for a collecting lens, the NA of which is greater than or equal to 0.6, to be used when visible light is presumed to be applied.

Further, the light irradiation unit 23 includes an aberration-correction mechanism that corrects aberration generated when the laser beam passes through the transparent substrate 20 of the device 3 and the window 18. The aberration-correction mechanism is located upstream of the collecting lens 12. For example, aberration of the laser beam to be collected can be corrected by utilizing a membrane minor as the mirror 11, which functions as the aberration-correction mechanism and which is capable of controlling the wavefront of reflected light. In this case, the mirror constitutes the aberration-correction mechanism. Alternatively, a pair of aberration-correction lenses may be provided upstream of the collecting lens as the aberration-correction mechanism.

In conventional apparatuses, it was not necessary to consider aberration. This is because a collection lens is disposed in the interior of a vacuum chamber and a device is exposed to a laser beam emitted from the front side of the device. Alternatively, this is because focal length is relatively long when the collection lens is configured to be disposed in the exterior of the vacuum chamber. However, the mass spectrometry apparatus of the present embodiment is configured in such a manner that the light source is disposed in the exterior of the vacuum chamber, and the laser beam is caused to pass through the permeable window 18 and further through the device 3 disposed in the vacuum chamber. Further, as a collection lens, the NA of which is great, is used, it is necessary to include a mechanism which corrects aberration in the apparatus.

The flight direction control unit 6 includes a drawing grid 14 disposed between the support mount 4 and the mass spectrometry unit 7, a variable voltage source 13 that applies a voltage between the drawing grid 14 and the device 3, and a cover 15. The cover 15 encloses the trajectory of the measurement target substance M, which is more toward the side of the mass spectrometry unit 7 than the grid 14. Further, the flight direction control unit 6 imparts a constant power to the measurement target substance M which has been desorbed from the device 3 to cause the desorbed measurement target substance M to fly toward the mass spectrometry unit 7.

The drawing grid 14 is a hollow electrode arranged between the device 3 and the mass spectrometry unit 7, the drawing grid 14 facing a surface of the device 3.

The variable voltage source 13 is connected to the support mount 4 and the drawing grid 14. This variable voltage source 13 forms a predetermined electric field with an electric potential difference between the support mount 4 and the drawing grid 14 being set as a predetermined electric potential difference.

The cover 15 is a hollow cylindrical member. The cover 15 is disposed between the drawing grid 14 and the mass spectrometry unit 7 in such a manner that the axis of the cylinder is parallel with the trajectory of the measurement target substance M and the trajectory of the measurement target substance M is enclosed by the cover 15. Further, in the cover 15, an end portion on the side of the drawing grid 14 is close to the drawing grid 14, and the other end portion on the side of the mass spectrometry unit 7 is in contact with a detector 24 of the mass spectrometry unit 7 to be described later.

The flight direction control unit 6 exerts control so that the variable voltage source 13 applies a voltage between the device 3 and the drawing grid 14 to form an electric field therebetween and so that a constant power is imparted to the measurement target substance M which has been desorbed from the device 3. The measurement target substance M, which has been imparted with a constant power by the electric field, is caused to fly from the device 3 toward the drawing grid 14 side at a predetermined acceleration. Further, the flying measurement target substance M passes through a hollow part of the cover 15 and flies to the mass spectrometry unit 7.

As described above, the support mount 4 is used as an electrode in TOF-MS. Therefore, the support mount 4 is basically constituted by a material having a conductive property. It is not necessary for the entirety of the support mount 4 to be conductive, but at least a surface on which the device 3 is placed should be constituted by a conductive material. Note that a light-transmitting portion which transmits the measurement light L may be an opening or may be constituted by a light transmissive material.

FIG. 3 illustrates a top view and a cross-sectional diagram of one example of the support mount 4. As illustrated in FIG. 3, an opening 4a that allows the measurement light L to transmit is provided in the center portion of the support mount 4. Even if the opening 4a is formed therein, the measurement target substance M can be caused to fly by a voltage being applied between the support mount 4 and the grid electrodes. This is because a portion surrounding the opening 4a functions as an electrode. As illustrated in FIG. 3, it is desirable for a film 41 made of a transparent electrode material to be provided on the top of this opening 4a. It is desirable for the film 41 to be provided on the opening 4a of the support mount 4 so as to be coplanar with the surface on which the device 3 is placed. The film may be formed on a transparent member (not shown) that fills the interior of the opening 4a For example, a film made of ITO (tin-doped indium oxide) having a thickness of approximately 100 nm may be formed by sputtering on a base substrate which has been located within the opening 4a. The base substrate is a transparent substrate made of a glass having a thickness of approximately 1 mm. When this film 41 made of the transparent electrode material is provided on the opening, it is possible to achieve sufficient acceleration when the measurement target substance flies.

FIG. 4 illustrates a top view of another example of the support mount. A device support mount 4′ illustrated in FIG. 4 is provided with a metal mesh 42, instead of the transparent electrode film 41, on the opening 4a. The size of the mesh is approximately between 10 μm and several tens μm. The measurement light L is collected and the spot diameter thereof is approximately 1 μm. Therefore, the measurement light L is capable of passing through the mesh and irradiating the surface of the device. When the measurement light L strikes metal wires of the metal mesh, the light will be reflected thereon, resulting in the amount of light which irradiates the surface of the device being reduced. Therefore, when such a device support mount 4′ is applied, the position where the measurement light L irradiates can be controlled by moving the device support mount in a XY direction, and the like in such a manner that the measurement is carried out in a state in which the surface of the device is exposed to the measurement light L which has been emitted from the light irradiation unit 23 and has passed through the mesh. For example, control can be performed by detecting the returned light of the measurement light L.

The mass spectrometry unit 7 includes a detector 24, an amplifier 16, and a data processing unit 17. The detector 24 detects the measurement target substance M which has been desorbed from the surface of the device 3 by being exposed to the measurement light L, passed through the drawing grid 14, and flied thereto. The amplifier 16 amplifies a value detected by the detector 24. The data processing unit 17 processes an output signal from the amplifier 16. Note that the detector 24 is disposed in the interior of the vacuum chamber 2, and the amplifier 16 and the data processing unit 17 are disposed in the exterior of the vacuum chamber 2.

Further, for example, a multi-channel plate (MCP) can be utilized as the detector 24. The mass spectrometry unit 7 detects a mass spectrum of the measurement target substance M at the data processing unit 17 and detects a mass (mass distribution) of the measurement target substance based on a detection result by the detector 24.

The mass spectrometry apparatus 1 is basically configured as described above.

Hereinafter, a mass spectrometry method using the mass spectrometry apparatus 1 will be described.

First, the measurement target substance M (or a sample containing the substance to be measure) is placed on a surface of the device 3, and the device 3 is located on the support mount 4.

Next, a predetermined voltage is applied, from the variable voltage source 13, between the device 3 and the drawing grid 14. Then, a measurement light L is emitted from the light irradiation unit 23 in response to a predetermined start signal, so as to expose the measurement target substance M to the measurement light L from the back side of the device 3.

When a metal microstructure layer 22 of the device 3 is irradiated by the measurement light L, an enhanced electric field caused by plasmons is formed on the surface of the device 3. Further, the measurement target substance M is desorbed from a measurement area by the light energy of the measurement light L enhanced by the enhanced electric field.

The desorbed measurement target substance M is drawn toward the direction of the drawing grid 14 by the electric field formed between the device 3 and the drawing grid 14, and accelerated. Further, the measurement target substance M passes through a hole at the center of the drawing grid 14, flies through the hollow portion of the cover 15 substantially straight toward the direction of the detector 24, reaches the detector 24, and is detected.

The speed of flight of the desorbed measurement target substance M depends on the mass of the substance. The speed of flight is higher as the mass of the substance is smaller. Therefore, substances sequentially reach the detector 24 in ascending order of the values of mass, in other words, the smallest mass substance reaches the detector 24 first.

An output signal from the detector 24 is amplified to a predetermined level by the amplifier 16, and then input to the data processing unit 17.

A synchronous signal which is synchronized with the start signal has been input to the data processing unit 17, and the data processing unit 17 can calculate the time of flight of the detected substance based on the synchronous signal and the output signal from the amplifier 16.

Further, the data processing unit 17 can calculate a mass spectrum by deriving the mass from the time of flight. Then, the data processing unit 17 detects the mass of the measurement target substance from the calculated mass spectrum, and identifies the measurement target substance. The data processing unit 17 includes, for example, a personal computer incorporating a program for mass spectrometry, and the like.

As soon as the detection of the mass of the measurement target substance M at a predetermined position is finished, the support mount 4 moves in an in-plane direction of the surface of the device 4. Further, a different position is irradiated with the measurement light and the aforementioned mass detection is repeated again so that two-dimensional spectrum data of the measurement target substance M can be obtained.

According to the mass spectrometry apparatus of the present embodiment, a sample plate that is transparent to a laser beam (measurement light) is used and the sample plate is exposed to the laser beam from the back side thereof. Therefore, the collecting lens does not interrupt the trajectory of the measurement target substance. Further, the collecting lens has a high degree of freedom in disposition, and the size of the collecting lens which collects the laser beam is not limited. Therefore, a lens, the numerical aperture of which is great, can be used. Further, as an aberration-correction mechanism is provided, it is possible to narrow down the spot diameter of the collected light to near the diffraction limit. Hence, the mass spectrometry image data having high resolution can be obtained.

Note that as in the aforementioned embodiment, when a device having an uneven microstructure layer on a surface is used as a sample plate, a surface of a sample, which is placed on the surface having the uneven microstructure, also has unevenness. Accordingly, it is preferable for an autofocus system, which enables the spot of the laser beam to be located on the surface of the sample all the time, to be included so as to obtain the two-dimensional mass spectrum data by causing the laser beam to perform two-dimensional scanning.

The autofocus system may be constituted by a focus position detection mechanism, and a position adjustment mechanism that adjusts the position of a collecting lens or a sample plate mechanism in the direction of the optical axis (in a Z direction). The focus position detection mechanism specifically includes a divided photodetector and an imaging optical system. Autofocusing can be carried out by the following steps. When a sample is irradiated by a laser beam, a weak reflection of the laser beam from the uneven microstructure layer is imaged on the divided photodetector, and a defocus of the laser beam is detected as a signal intensity ratio of the divided photodetector. Then, a difference in the signal intensity ratios (which corresponds to the amount of the defocus) is fed back to the position adjustment mechanism that adjusts the position of a collecting lens or a sample plate mechanism in the direction of the optical axis.

Next, a second embodiment of the mass spectrometry apparatus of the present invention will be described.

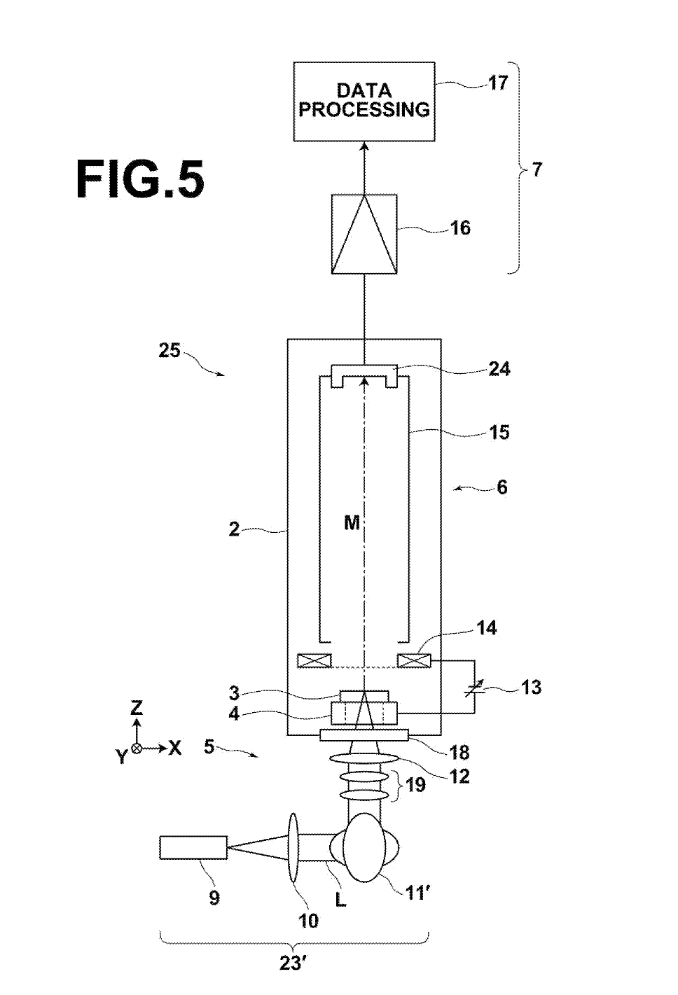

FIG. 5 is a schematic diagram illustrating the configuration of a mass spectrometry apparatus according to the second embodiment of the present invention. A mass spectrometry apparatus 25 differs from that of the first embodiment in the configuration of a light irradiation unit 23′. The configurations other than that of the light irradiation unit 23′ are similar to those of the mass spectrometry apparatus 1. The same reference numerals are assigned to the same members and configurations, and descriptions thereof are omitted.

In the present embodiment, the light irradiation unit 23 includes a galvano-mirror pair 11′ as a mirror that reflects the laser beam, which has been collimated by a collimating lens, onto the side of the collecting lens 12. When the collecting lens 12 is irradiated by a laser beam with an angle formed with respect to the central axis of the collecting lens 12 by using the galvano-mirror pair 11′, a point where the laser beam is collected on the surface of the device 3 can be two-dimensionally swept along the surface. That is, in the mass spectrometry apparatus 25, the galvano-mirror pair 11′ constitutes a laser beam sweeping unit which is the two-dimensional scanning mechanism.

If the galvano-mirror pair 11′ is used, it is possible to control the collecting point of a laser beam with higher positioning accuracy and at higher speed and to obtain the two-dimensional mass spectrum data with higher resolution and at higher speed, compared to a case that a position where the laser beam is collected on the measurement target substance M is moved by moving the support mount 4 in a XY direction as in the mass spectrometry apparatus 1.

Further, in the present embodiment, an aberration-correction lens 19 constituted by a pair of lenses is provided between the galvano-mirror pair 11 and the collecting lens 12. The aberration-correction lens 19 is capable of correcting aberration which occurs at the light irradiation unit 23 so that the surface of the device can be irradiated by the laser beam precisely.

In the mass spectrometry apparatus according to the second embodiment as well, mass spectrometry data with high resolution can be obtained in a manner similar to the first embodiment.

In the mass spectrometry apparatus of each embodiment described above, it is preferable for an ionization accelerating agent to be adhered to the surface of the sample plate 3. Examples of the ionization accelerating agent may include sinapic acid, ferulic acid, gentisic acid, dithranol, and the like.

When the ionization accelerating agent is applied, it is possible to desorb and ionize a sample, and to suppress deformation or deterioration of the measurement target substance by a laser beam (measurement light) with a lower power.

Further, a surface modification R that is capable of capturing the measurement target substance M may be applied onto the surface of the mass spectrometry device 3 which is the sample plate. For example, when the measurement target substance is an antigen, the surface is modified with an antibody which can be specifically bonded to the antigen. Thereby, it is possible to enhance the concentration of the measurement target substance M on the surface in contact with the sample so that the sensitivity can be improved.

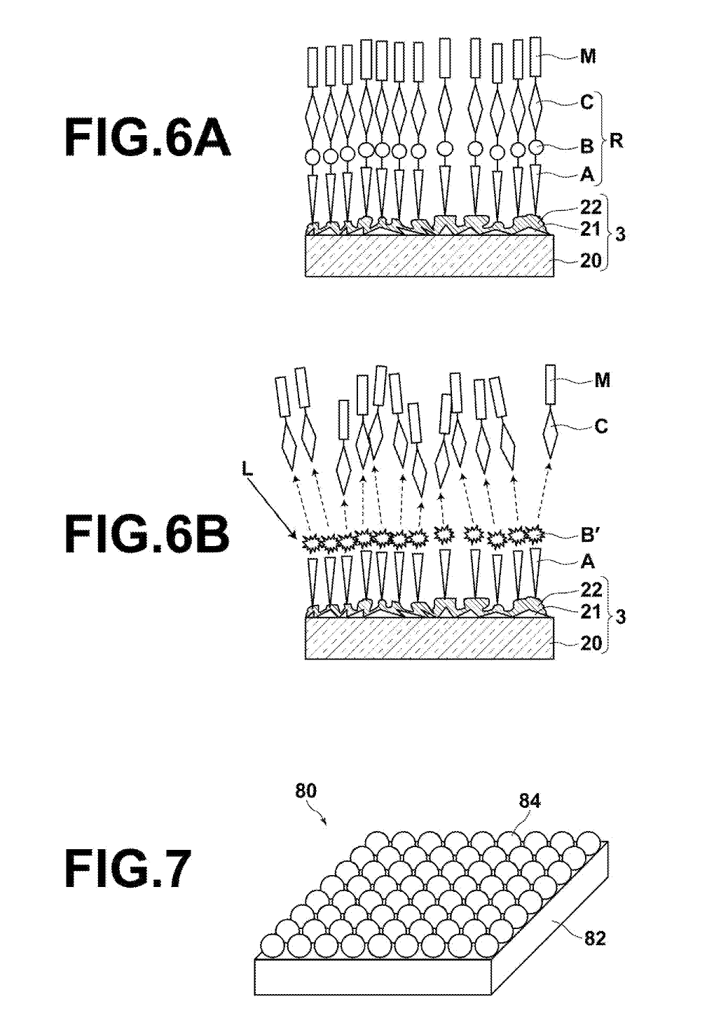

FIG. 6A is a cross-sectional diagram illustrating a state in which a surface modification R is applied onto the surface of the mass spectrometry device 3. FIG. 6B is a cross-sectional diagram illustrating a state in which measurement target substances are desorbed from the device 3 illustrated in FIG. 6A. Note that a surface modification R and constituent elements of the surface modification R are enlarged and illustrated so that they are easily recognized in FIGS. 6A and 6B.

As illustrated in FIG. 6A, the surface modification R includes a first linker function unit A, a second linker function C, and a decomposition function unit B on the surface of the device 3. The first linker function unit A binds to the surface of the device 3. The second linker function unit C binds to the measurement target substance M. The decomposition function unit B is present between the first linker function unit A and the second linker function unit C, and is decomposed by the electric field generated by the irradiation of the measurement light. In the example shown in the Figure, the measurement target substance M is disposed in the vicinity of the measurement area on the device of the mass spectrometry, the surface modification R intervening between the measurement target substance M and the measurement area.

Note that the surface modification R may be one substance that contains all of the first linker function unit A, the decomposition function unit B, and the second linker function unit C. Alternatively, each of the first linker function unit A, the decomposition function unit B, and the second linker function unit C may be a different substance. Alternatively, a combination of the first linker function unit A and the decomposition function unit B or a combination of the decomposition function unit B and the second linker function unit C may be one substance.

Here, when the device 3 is irradiated by the measurement light L, localized plasmons are generated on the surface of the metal microstructure layer 22 and an enhanced electric field is generated on the surface of the measurement area. Further, the light energy of the measurement light is increased in the vicinity of the surface of the measurement area by the enhanced field generated on the surface thereof.

The decomposition function unit B of the surface modification R is decomposed by the increased energy. Then, the second linker function unit C binding to the measurement target substance M is desorbed from the surface of the measurement area, as illustrated in FIG. 6B.

When the surface modification is applied in such a manner, the measurement target substance can be desorbed from the surface of the microstructure. In addition, as the measurement target substance M binds to the device 3 with the surface modification R intervened therebetween, the measurement target substance M can be present apart from the surface of the device 3 in the measurement area.

Here, an electric field enhanced effect obtained on the surface of the device 3 is an electric field enhancement effect by the near-field light generated by localized plasmons. Therefore, the electric field enhanced effect obtained on the surface of the device 3 attenuates exponentially as distance from the surface become longer. Hence, as illustrated in FIG. 6A, when the measurement target substance M is present relatively away from the surface, the light energy of the measurement light which irradiates the measurement target substance M can be less influenced by the electric field enhancement. That is, it is possible to suppress deterioration in the measurement target substance due to the enhanced light energy and to perform mass spectrometry precisely.

Note that this decomposition function unit B of the surface modification R corresponds to the aforementioned ionization accelerating agent.

In the aforementioned embodiment, the mass spectrometry device 3 that includes the transparent and uneven microstructure 21 and the metal microstructure layer 22 formed thereon is used as a sample plate, the uneven microstructure 21 being made of boehmite and formed on the transparent substrate 20. Such configuration, in which the metal microstructure can induce localized plasmons on the surface thereof by irradiation of the measurement light, is not limited to the aforementioned embodiment. Hereinafter, a mass spectrometry device (sample plate) according to another embodiment will be described.

FIG. 7 is a perspective diagram illustrating the schematic configuration of another example of the mass spectrometry device.

A mass spectrometry device 80 illustrated in FIG. 7 includes a transparent substrate 82 and a great number of metal microparticles 84 arranged on the transparent substrate 82. The same substrate as in the case of the aforementioned embodiment may be employed as the substrate 82. The substrate is made of a material which has high transmittance with respect to the measurement light and which supports the metal microparticles in an electrically insulated manner. Examples of the material may include quartz, sapphire, and the like.

The great number of the metal microparticles 84, each of which has a sufficient size to induce localized plasmons, are fixed in a state in which they are dispersed on one surface of the substrate 82.

Further, each of the metal microparticles 84 can be formed by various types of metals that constitute the aforementioned uneven microstructure layer made of metal. Further, the shape of the metal microparticle 84 is not particularly limited. For example, the shape may be sphere, disc-type, or rectangular parallelepiped. When a maximum length (which corresponds to the length of the diameter thereof when the shape is sphere or disc-type, and which corresponds to the length of the long side thereof when the shape is rectangular parallelepiped) of the metal microparticles 84 is shorter than the wavelength of the laser beam which is the measurement light, localized plasmons are induced by irradiation with the laser beam.

In the mass spectrometry device 80 configured in such a manner as well, an enhanced electric field can be generated by the measurement light irradiating a detection surface of the detector on which the metal microparticles are placed.

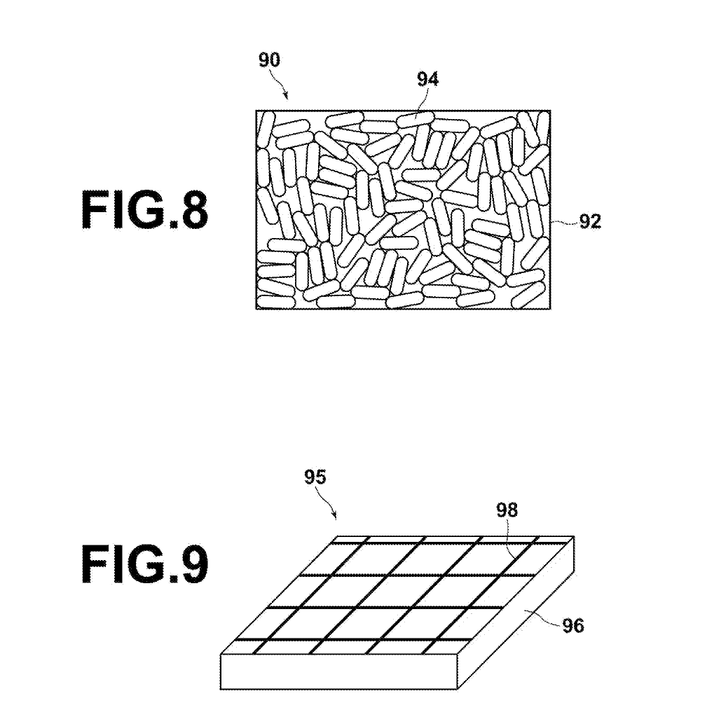

FIG. 8 is a top view illustrating the schematic configuration of another example of the mass spectrometry device. A mass spectrometry device 90 illustrated in FIG. 8 includes a transparent substrate 92 and a great number of metallic nanorods 94 arranged on the substrate 92. The transparent substrate 92 is similar to the example described above.

Each metallic nanorod 94 is of a size that is capable of inducing localized plasmons, and is a stick-shaped metal nanoparticle in which a major axis length and a minor axis length differ from each other. The metallic nanorods 94 are fixed in a state in which they are dispersed on one surface of the substrate 92. In each metallic nanorod 94, the minor axis length is approximately between 3 nm and 50 nm, and the major axis length is approximately between 25 nm and 1000 nm. When the major axis length is shorter than the wavelength of the laser beam which is the measurement light, localized plasmons are induced by irradiation with the laser beam.

The metallic nanorod 94 can be manufactured in a manner similar to the aforementioned metal microparticle. Note that the configuration of the metallic nanorod is disclosed in detail, for example in Japanese Unexamined Patent Publication No. 2007-139612.

In the mass spectrometry device 90 configured in such a manner as well, an enhanced electric field can be generated by the measurement light irradiating a detection surface on which the metallic nanorods are arranged.

Further, FIG. 9 is a perspective diagram illustrating the schematic configuration of another example of the mass spectrometry device.

A mass spectrometry device 95 illustrated in FIG. 9 includes a transparent substrate 96 and a great number of metallic thin wires 98 arranged on the substrate 96. The transparent substrate 96 is similar to the aforementioned substrate.

The metallic thin wire 98 is a linear member of a line width that is capable of inducing localized plasmons. The metallic thin wires 98 are in a lattice pattern on one surface of the substrate 96. The metallic thin wire 98 can be manufactured in a manner similar to the aforementioned metal microstructure layer and the metallic microparticle. Further, the method for manufacturing the metallic thin wire 98 is not particularly limited, and the metallic thin wire 98 can be manufactured by various types of methods for manufacturing a metallic wire, such as vapor deposition, plating, and the like.

Here, it is preferable for the line width of the metallic thin wire 98 to be less than or equal to 50 nm, and particularly less than or equal to 30 nm. Further, the pattern in which the metallic thin wires 98 are arranged is not particularly limited. For example, a plurality of metallic thin wires may be arranged parallel to each other without intersecting each other. Further, the shape of the metallic thin wire is not limited to a straight line, and may be a curve.

In the mass spectrometry device 95 configured in such a manner as well, an enhanced electric field due to the localized plasmons can be generated by the measurement light irradiating a detection surface on which the metallic thin wire 98 are arranged.

Note that the mass spectrometry device is not limited to the aforementioned configurations, and any of the configurations above may be combined so as to induce localized plasmons.

As described above, the mass spectrometry apparatus according to the present invention was described in detail. The present invention is not limited to the embodiments described above, and various modification or changes may be made without departing from the scope of the invention.

For example, the present invention is described with reference to a case that the mass spectrometry apparatus is a TOF-MS. However, apparatuses that perform mass spectrometry of a sample ion which has been ionized are not limited to the TOF type, and may be an IT (Ion Trap type), an FT (ICR) (a Fourier-Transform Ion Cyclotron Resonance type), a QqTOF (a Quadrupole-TOF type) which is a combination of a plurality of mass spectrometry methods, a TOF-TOF (a TOF connection type), and the like.

What is claimed is:

1. A mass spectrometry apparatus comprising:
a sample plate to which a measurement target substance is adhered, the sample plate being transparent to a laser beam;
a support mount on which the sample plate is placed, a part of the support mount being a light transmitting portion that transmits a laser beam;
a light irradiation unit that is disposed on a side opposite a surface on which the sample plate is placed in the support mount, that causes the laser beam to pass through the light transmitting portion of the support mount, and that irradiates the laser beam onto the measurement target substance from the back side of the sample plate, the light irradiation unit being provided with a laser source that outputs a laser beam, a collecting lens that collects the laser beam onto the measurement target substance, and an aberration-correction mechanism that corrects aberration which occurs when the laser beam is collected; and
a detector that detects the measurement target substance which has been desorbed from the surface of the sample plate and ionized, by irradiation with the laser beam.

2. The mass spectrometry apparatus of claim 1 that further comprises a two-dimensional scanning mechanism which causes the laser beam to perform a two-dimensional scanning in an in-plane direction of the sample plate.

3. The mass spectrometry apparatus of claim 1, wherein the support mount comprises a body of the support mount which is constituted by a conductive member, the light transmitting portion of the conductive member being an opening; and
a light-transmitting conductive film which is provided on the opening to be coplanar with the surface on which the sample plate is placed.

4. The mass spectrometry apparatus of claim 3, wherein the light-transmitting conductive film is made of a transparent oxidized conductive material.

5. The mass spectrometry apparatus of claim 3, wherein the light-transmitting conductive film is a metal mesh.

6. The mass spectrometry apparatus of claim 1, wherein the sample plate has a substrate that is transparent to the laser beam and a metal microstructure formed on the substrate, which excites localized plasmons by irradiation with the laser beam.

7. The mass spectrometry apparatus of claim 1, wherein an ionization accelerating agent is adhered to the surface of the sample plate.

8. The mass spectrometry apparatus of claim 2, wherein the two-dimensional scanning mechanism is a plane-direction drive unit which is provided on the support mount.

9. The mass spectrometry apparatus of claim 2, wherein the two-dimensional scanning mechanism is a laser beam sweeping unit which sweeps the laser beam in an in-plane direction on the sample plate and which is provided in the light irradiation unit.

10. The mass spectrometry apparatus of claim 2 that comprises an autofocus system which automatically adjusts focusing of the laser beam when the laser beam performs scanning.
